(19) United States
(12) Patent Application Publication
(10) Pub. No.: US 2009/0105354 A1
(43) Pub. Date: Apr. 23, 2009

(54) DISPERSION OF ZIRCONIUM DIOXIDE AND ZIRCONIUM MIXED OXIDE

(75) Inventors: Monika Oswald, Hanau (DE); Corinna Kissner, Hanau (DE); Wolfgang Lortz, Wachtersbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/722,122

(22) PCT Filed: Dec. 20, 2005
(86) PCT No.: PCT/EP05/56940

§ 371 Date: Jun. 19, 2007

(30) Foreign Application Priority Data
Dec. 22, 2004 (DE) 102004061697.3

(51) Int. Cl. B01J 13/00

(52) U.S. Cl. 516/98

(57) ABSTRACT

Dispersion of zirconium dioxide having a solids content of from 30 to 75 wt. %, based on the total amount of the dispersion, and a median value of the particle size distribution in the dispersion of less than 200 nm, obtainable by predispersing a zirconium dioxide powder and/or a zirconium mixed oxide powder having a ZrC>2 content of at least 70 wt. %, the powders being in the form of aggregated primary particles and having no internal surface and a BET surface area of the powder of 60±15 m2/g, in a dispersing agent in the presence of from 0.1 to 5 wt. %, based on the total amount of the dispersion, of a surface-modifying agent with an energy input of less than 200 KJ/m3, dividing the predispersion obtained into at least two part streams, placing these part streams under a pressure of at least 500 bar in a high-energy mill and decompress them via a nozzle, these part streams colliding with one another in a gas- or liquid-filled reaction chamber and thereby being ground, and optionally subsequently adjusting the dispersion to the desired content with further dispersing agent. It can be used for the production of ceramic layers, membranes and shaped articles.

The invention relates to a dispersion of zirconium dioxide and its preparation and use.

Zirconium dioxide dispersions are ideal starting materials for the production of ceramic mouldings, coatings and for polishing surfaces of glass and metal.

The zirconium dioxide powders on which the dispersion are based as a rule originate from sol/gel processes or from flame pyrolysis processes.

The powders from sol/gel processes as a rule have a low degree of aggregation or agglomeration and, at approx. 10 to 30 m²/g, have relatively low BET surface areas. In dispersions, the powders are often stabilized against reaggregation or reagglomeration by means of additives. These additives react with molecular groups on the surface of the zirconium dioxide particles.

The powders from flame pyrolysis processes are as a rule in aggregated form. Dispersion of these powders often leads to dispersions which are not very stable. A rapid sedimentation, caking and thickening take place, and redispersion is often not possible. This effect is intensified if powders produced by flame pyrolysis having a high BET surface area are employed. These moreover show a high viscosity and are therefore not very suitable for uses for which a high degree of filling with simultaneous pourability of the dispersion is advantageous.

It is nevertheless desirable to be able to make use of the properties which accompany the particular aggregate structure of zirconium dioxide powders prepared by flame pyrolysis, for example in the polishing of surfaces or in the production of ceramic layers.

The object of the invention is to provide a stable, low-viscosity, very finely divided zirconium dioxide dispersion having a high degree of filling. The object of the invention is furthermore to provide a process for the preparation of this dispersion.

The present invention provides a dispersion of zirconium dioxide having a solids content of from 30 to 75 wt. %, based on the total amount of the dispersion, and a median value of the particles in the dispersion of less than 200 nm, obtainable by predispersing a zirconium dioxide powder and/or a zirconium mixed oxide powder, each having a ZrO₂ content of at least 70 wt. %, the powders being in the form of aggregated primary particles and having no internal surface and a BET surface area of the powder of 60±15 m²/g, in a dispersing agent in the presence of from 0.1 to 5 wt. %, based on the total amount of the dispersion, of a surface-modifying agent with an energy input of less than 200 KJ/m³, dividing the predispersion obtained into at least two part streams, placing these part streams under a pressure of at least 500 bar in a high-energy mill and decompress them via a nozzle, these part streams colliding with one another in a gas- or liquid-filled reaction chamber and thereby being ground, and optionally subsequently adjusting the dispersion to the desired content with further dispersing agent.

Powders which are prepared by flame hydrolysis can preferably be employed here.

In this context, flame pyrolysis is to be understood as meaning that the powder has been obtained by means of a flame hydrolysis or a flame oxidation. Flame hydrolysis is to be understood as meaning, for example, the formation of zirconium dioxide by combustion of zirconium tetrachloride in a hydrogen/oxygen flame. Flame oxidation is to be understood as meaning, for example, the formation of zirconium dioxide by combustion of an organic zirconium dioxide precursor in a hydrogen/oxygen flame.

Median value is to be understood as meaning the d₅₀ value of the volume-weighted particle size distribution. The median value of the particles in the dispersion according to the invention is less than 200 nm. In this context, particles are to be understood as meaning primary particles, aggregates and agglomerates such as are present in the dispersion. The d₅₀ value can preferably be between 70 and 200 nm.

In the context of the invention, surface-modified is to be understood as meaning that at least some of the hydroxyl groups on the surface of the powder have reacted with a surface-modifying agent to form a chemical bond. The chemical bond is preferably a covalent, ionic or a coordinative bond between the surface-modifying agent and the particle, but also hydrogen bridge bonds. A coordinative bond is understood as formation of a complex. Thus, e.g. a Brönsted or Lewis acid/base reaction, formation of a complex or esterification can take place between the functional groups of the modifying agent and the particle. The functional groups which the modifying agent contains are preferably carboxylic acid groups, acid chloride groups, ester groups, nitrile and isonitrile groups, OH groups, SH groups, epoxide groups, anhydride groups, acid amide groups, primary, secondary and tertiary amino groups, Si—OH groups, hydrolysable radicals of silanes or C—H acid groupings, such as in beta-dicarbonyl compounds. The surface-modifying agent can also contain more than one such functional group, such as e.g. in betaines, amino acids and EDTA. Suitable surface-modifying agents can be:

Saturated or unsaturated mono- and polycarboxylic acids having 1 to 24 carbon atoms, such as e.g. formic acid, acetic acid, propionic acid, butyric acid, pentanoic acid, hexanoic acid, acrylic acid, methacrylic acid, crotonic acid, citric acid, adipic acid, succinic acid, glutaric acid, oxalic acid, maleic acid, fumaric acid, itaconic acid and stearic acid, as well as the corresponding acid anhydrides, chlorides, esters and amides as well as salts thereof, in particular ammonium salts thereof. Those carboxylic acids in which the carbon chain is interrupted by O, S or NH groups, such as ether-carboxylic acids (mono- and polyether-carboxylic acids as well as the corresponding acid anhydrides, chlorides, esters and amides), oxacarboxylic acids, such as 3,6-dioxaheptanoic acid and 3,6,9-trioxadecanoic acid, are also suitable.

Mono- and polyamines of the general formula Q₃₋ₙNHₙ, where n=0, 1 or 2 and the radicals Q are independent of one another, with C₁-C₁₂-alkyl, in particular C₁-C₆-alkyl and particularly preferably C₁-C₄-alkyl, e.g. methyl, ethyl, n-propyl and i-propyl and butyl. Furthermore aryl, alkaryl or aralkyl having 6 to 24 carbon atoms, such as e.g. phenyl, naphthyl, tolyl and benzyl.

Furthermore polyalkylenamines of the general formula Y₂N(-Z-NY)_{y}—Y, wherein Y is independent of Q or N, wherein Q is as defined above, y is an integer from 1 to 6, preferably 1 to 3, and Z is an alkylene group having 1 to 4, preferably 2 or 3 carbon atoms. Examples are methylamine, dimethylamine, trimethylamine, ethylamine, aniline, N-methylaniline, diphenylamine, triphenylamine, toluidine, ethylenediamine and diethylenetriamine.

Preferred beta-dicarbonyl compounds having 4 to 12, in particular 5 to 8 carbon atoms, such as e.g. acetylacetone, 2,4-hexanedione, 3,5-heptanedione, acetoacetic acid, acetoacetic acid C₁-C₄-alkyl esters, such as ethyl acetoacetate, diacetyl and acetonylacetone.

Amino acids, such as beta-alanine, glycine, valine, aminocaproic acid, leucine and isoleucine.

Silanes which contain at least one non-hydrolysable group or a hydroxyl group, in particular hydrolysable organosilanes, which additionally contain at least one non-hydrolysable radical. Silanes of the general formula RₐSiX₄₋ₐ can preferably serve as the surface-modifying reagent, wherein the radicals R are identical or different and represent non-hydrolysable groups, the radicals X are identical or different and denote hydrolysable groups or hydroxyl groups and a has the value 1, 2 or 3. The value a is preferably 1.

In the general formula, the hydrolysable groups X, which can be identical or different from one another, are, for example, hydrogen or halogen (F, Cl, Br or I), alkoxy (preferably C₁-C₆-alkoxy, such as e.g. methoxy, ethoxy, n-propoxy, i-propoxy and butoxy), aryloxy (preferably C₆-C₁₀-aryloxy, such as e.g. phenoxy), acyloxy (preferably C₁-C₆-acyloxy, such as e.g. acetoxy or propionyloxy), alkylcarbonyl (preferably C₂-C₇-alkylcarbonyl, such as e.g. acetyl), amino, monoalkylamino or dialkylamino having preferably 1 to 12, in particular 1 to 6 carbon atoms. Preferred hydrolysable radicals are halogen, alkoxy groups and acyloxy groups. Particularly preferred hydrolysable radicals are C₁-C₄-alkoxy groups, in particular methoxy and ethoxy.

The non-hydrolysable radicals R, which can be identical or different from one another, can be non-hydrolysable radicals R with or without a functional group.

The non-hydrolysable radical R without a functional group can be, for example, alkyl (preferably C₁-C₈-alkyl, such as methyl, ethyl, n-propyl, isopropyl, n-butyl, sec-butyl and tert-butyl, pentyl, hexyl, octyl or cyclohexyl), alkenyl (preferably C₂-C₆-alkenyl, such as e.g. vinyl, 1-propenyl, 2-propenyl and butenyl), alkynyl (preferably C₂-C₆-alkynyl, such as e.g. acetylenyl and propargyl), aryl (preferably C₆-C₁₀-aryl, such as e.g. phenyl and naphthyl) as well as corresponding alkaryls and aralkyls (e.g. tolyl, benzyl and phenethyl). The radicals R and X can optionally contain one or more conventional substituents, such as e.g. halogen or alkoxy. Alkyltrialkoxysilanes are preferred. Examples are: CH₃SiCl₃, CH₃Si (OC₂H₅)₃, CH₃Si (OCH₃)₃, C₂H₅SiCl₃, C₂H₅Si (OC₂H₅)₃, C₂H₅Si (OCH₃)₃, C₃H₇Si (OC₂H₅)₃, (C₂H₅O)₃SiC₃H₆Cl, (CH₃)₂SiCl₂, (CH₃)₂Si(OC₂H₅)₂, (CH₃)₂Si(OH)₂, C₆H₅Si(OCH₃)₃, C₆H₅Si (OC₂H₅)₃, C₆H₅CH₂CH₂Si (OCH₃)₃, (C₆H₅)₂SiCl₂, (C₆H₅)₂Si(OC₂H₅)₂, (i-C₃H₇)₃SiOH, CH₂═CHSi (OOCCH₃)₃, CH₂═CHSiCl₃, CH₂═CH—Si (OC₂H₅)₃, CH₂═CHSi (OC₂H₅)₃, CH₂═CH—Si (OC₂H₄OCH₃)₃, CH₂═CH—CH₂—Si (OC₂H₅)₃, CH₂═CH—CH₂—Si (OC₂H₅)₃, CH₂═CH—CH₂Si (OOOCH₃)₃, n-C₆H₁₃—CH₂—CH₂—Si(OC₂H₅)₃ and n-C₈H₁₇—CH₂CH₂—Si(OC₂H₅)₃.

The non-hydrolysable radical R having a functional group can include e.g. as the functional group an epoxide (e.g. glycidyl or glycidyloxy), hydroxyl, ether, amino, monoalkylamino, dialkylamino, optionally substituted anilino, amide, carboxyl, acryl, acryloxy, methacryl, methacryloxy, mercapto, cyano, alkoxy, isocyanato, aldehyde, alkylcarbonyl, acid anhydride and phosphoric acid group. These functional groups are bonded to the silicon atom via alkylene, alkenylene or arylene bridge groups, which can be interrupted by oxygen or —NH— groups. The bridge groups preferably contain 1 to 18, preferably 1 to 8 and in particular 1 to 6 carbon atoms.

The divalent bridge groups mentioned and the substituents optionally present, such as in the case of the alkylamino groups, are derived e.g. from the abovementioned monovalent alkyl, alkenyl, aryl, alkaryl or aralkyl radicals. The radical R can of course also contain more than one functional group.

Preferred examples of non-hydrolysable radicals R having functional groups are a glycidyl or a glycidyloxy-(C₁-C₂₀)-alkylene radical, such as beta-glycidyloxyethyl, gamma-glycidyloxypropyl, delta-glycidyloxybutyl, epsilon-glycidyloxypentyl, omega-glycidyloxyhexyl and 2-(3,4-epoxycyclohexyl)ethyl, a (meth)acryloxy-(C₁-C₆)-alkylene radical, e.g. (meth)acryloxymethyl, (meth)acryloxyethyl, (meth)acryloxypropyl or (meth)acryloxybutyl, and a 3-isocyanatopropyl radical.

Examples of corresponding silanes are gamma-glycidyloxypropyltrimethoxysilane (GPTS), gamma-glycidyloxypropyltriethoxysilane (GPTES), 3-isocyanato-propyltriethoxysilane, 3-isocyanatopropyldimethylchlorosilane, 3-aminopropyltrimethoxysilane (APTS), 3-aminopropyltriethoxysilane (APTES), N-(2-aminoethyl)-3-aminopropyltrimethoxysilane, N—[N′-(2′-aminoethyl)-2-aminoethyl]-3-aminopropyltrimethoxysilane, hydroxymethyltriethoxysilane, 2-[methoxy(polyethylenoxy)propyl]trimethoxysilane, bis-(hydroxyethyl)-3-aminopropyltriethoxysilane, N-hydroxyethyl-N-methylaminopropyltriethoxysilane, 3-(meth)acryloxypropyltriethoxysilane and 3-(meth)acryloxypropyltrimethoxysilane.

It is particularly advantageous if the zirconium dioxide powders or zirconium mixed oxide powders present in the dispersion according to the invention are surface-modified with 3-aminopropyltriethoxysilane (AMEO), ammonium salts of polycarboxylic acids, for example Dolapix CE64 (Zschimmer & Schwarz), or tetraalkylammonium hydroxides, such as tetramethylammonium hydroxide or tetraethylammonium hydroxide. Mixtures of the abovementioned compounds can also be employed.

Suitable dispersing agents of the dispersion according to the invention are water and/or organic solvents, such as alcohols having 1 to 8 carbon atoms, in particular methanol, ethanol, n-propanol and i-propanol, butanol, octanol, cyclohexanol, ketones having 1 to 8 carbon atoms, in particular acetone, butanone and cyclohexanone, esters, in particular ethyl acetate and glycol esters, ethers, in particular diethyl ether, dibutyl ether, anisole, dioxane, tetrahydrofuran and tetrahydropyran, glycol ethers, in particular mono-, di-, tri- and polyglycol ethers, glycols, in particular ethylene glycol, diethylene glycol and propylene glycol, amides and other nitrogen compounds, in particular dimethylacetamide, dimethylformamide, pyridine, N-methylpyrrolidine and acetonitrile, sulfoxides and sulfones, in particular sulfolane and dimethylsulfoxide, nitro compounds, such as nitrobenzene, halohydrocarbons, in particular methylene chloride, chloroform, carbon tetrachloride, tri- and tetrachloroethene and ethylene chloride, chlorofluorocarbons, aliphatic, alicyclic or aromatic hydrocarbons having 5 to 15 carbon atoms, in particular pentane, hexane, heptane and octane, cyclohexane, benzines, petroleum ether, methylcyclohexane, decalin, benzene, toluene and xylenes. Particularly preferred organic dispersing agents are ethanol, n- and i-propanol, ethylene glycol, hexane, heptane, toluene and o-, m- and p-xylene.

Mixtures of the abovementioned compounds can also serve as dispersing agents, in which case these must be miscible and form only one phase.

Water is a particularly preferred dispersing agent.

A zirconium mixed oxide powder having a ZrO₂ content of at least 70 wt. % is to be understood as meaning a powder which contains at least one further metal oxide component as a mixed oxide component. This can preferably be yttrium and/or hafnium. The content of hafnium dioxide can preferably be 1 to 4 wt. % and the content of yttrium oxide can preferably be 2 to 30 wt. %, in each case based on the total amount of powder. A yttrium content of from 3 to 15 wt. % can be particularly preferred.

For example, a zirconium mixed oxide powder having the following features can preferably be employed:
average primary particle diameter: <20 nm, preferably 10-16 nm, particularly preferably 12-14 nm
aggregate parameters: average area <10,000 nm², preferably 5,000-8,000 nm², average equivalent circular diameter <100 nm, preferably 50-90 nm, average aggregate circumference <700 nm, preferably 450-600 nm
content of zirconium dioxide (ZrO₂) 95-99.9 wt. %, preferably >97 wt. %, content of hafnium dioxide (HfO₂) 0.1 to 4 wt. %, preferably 1-2.5 wt. %, carbon 0 to 0.15 wt. %, chloride 0 to 0.05 wt. %, in each case based on the total amount of the powder.

The average maximum aggregate diameter is preferably less than 150 nm, particularly preferably 100-150 nm, and the average minimum aggregate diameter is less than 100 nm, particularly preferably 60-90 nm.

The powder preferably shows only the reflections of monoclinic and tetragonal zirconium dioxide in X-ray diffraction analysis. Preferably, the content of the tetragonal phase is 20% to 70%, and a content of the tetragonal phase of from 30% to 50% is particularly preferred. The powder has no internal surface.

The tamped density is preferably 100±20 g/l, the loss on drying is not more than 2.0 wt. %, the loss on ignition is not more than 3.0 wt. % and the pH is preferably from 4.0 to 6.0, determined in a 4 percent strength aqueous dispersion.

It can be obtained by
atomizing a solution comprising starting materials for the zirconium/hafnium mixed oxide powder, which is obtained by mixing
   a solution which contains at least a zirconium carboxylate, a hafnium carboxylate and/or a carboxylate which has contents of zirconium and hafnium in an organic solvent or organic solvent mixture
   a solution which contains at least a zirconium alcoholate, a hafnium alcoholate and/or an alcoholate which has contents of zirconium and hafnium in an organic solvent or organic solvent mixture
   and in which the starting compounds are present in a ratio corresponding to the ratio of zirconium dioxide and hafnium dioxide desired later, and in which the weight ratio of carboxylate/alcoholate is 30:70 to 90:10,
   by means of an atomizing gas to form an aerosol,
   burning the aerosol in a flame generated from a fuel gas, preferably hydrogen, and air (primary air, into a reaction chamber and additionally introducing air (secondary air) into the reaction chamber such that
      lambda₁, defined as the ratio of the oxygen present from the total air employed/oxygen necessary for combustion of the fuel gas, is 1.5 to 4 and
   lambda₂, defined as the ratio of the oxygen present from the total air employed/oxygen necessary for combustion of the starting materials and the fuel gas, is greater than 1 or equal to 1 and lambda₁ is >lambda₂,
   and the dwell time of the starting materials in the flame is 5 to 30 milliseconds,
   cooling the hot gases and the solid product and subsequently separating the solid product off from the gases.

Alcoholates which can preferably be employed are zirconium(IV) ethylate, zirconium(IV) n-propylate, zirconium(IV) n-propylate, zirconium(IV) iso-propylate, zirconium (IV) n-butylate, zirconium(IV) tert-butylate, hafnium(IV) ethylate, hafnium(IV) n-propylate, hafnium(IV) n-propylate, hafnium(IV) iso-propylate, hafnium(IV) n-butylate and/or hafnium(IV) tert-butylate.

Alcoholates which contain a zirconium and a hafnium component are particularly preferred.

Carboxylates which can preferably be employed are zirconium acetate, zirconium propionate, zirconium oxalate, zirconium octoate, zirconium 2-ethyl-hexanoate, zirconium neodecanoate and/or zirconium stearate, hafnium acetate, hafnium propionate, hafnium oxalate, hafnium octoate, hafnium 2-ethyl-hexanoate and/or hafnium neodecanoate.

Carboxylates which contain a zirconium and a hafnium component are particularly preferred.

Hafnium compounds are as a rule contained in zirconium compounds in a content of from 1 to 5 wt. %. However, zirconium compounds and hafnium compounds can also be prepared in degrees of purity of 99 wt. % and more. The desired hafnium dioxide content of from 0.01 to 4 wt. % can be established by any desired combination of the hafnium contents of the starting compounds.

Methanol, ethanol, n-propanol, iso-propanol, n-butanol, tert-butanol, 2-propanone, 2-butanone, diethyl ether, tert-butyl methyl ether, tetrahydrofuran, C₁-C₈-carboxylic acids, ethyl acetate, toluene and/or benzine can preferably be employed as organic solvents or as a constituent of organic solvent mixtures.

In a particularly preferred embodiment, the solutions which contain zirconium carboxylate and/or hafnium carboxylate simultaneously contain the carboxylic acid on which the carboxylate is based, and the solutions which contain zirconium alcoholate and/or hafnium alcoholate simultaneously contain the alcohol on which the alcoholate is based.

A further preferred zirconium mixed oxide powder has the following features:

It is in the form of aggregated primary particles having the following physico-chemical parameters:
content of yttrium, calculated as yttrium oxide Y₂O₃ and determined by chemical analysis, of from 5 to 15 wt. %, based on the mixed oxide powder,
contents of yttrium of individual primary particles, calculated as yttrium oxide Y₂O₃ and determined by TEM-EDX, corresponding to the content in the powder ±10%,
content at room temperature, determined by X-ray diffraction and based on the mixed oxide powder
of monoclinic zirconium dioxide <1 to 10 wt. %,
content of carbon of less than 0.2 wt. %.

It can be obtained by mixing an organic zirconium dioxide precursor and an inorganic yttrium oxide precursor, in each case dissolved in an organic solvent or organic solvent mixture, in a ratio corresponding to the ratio of zirconium and yttrium desired later, atomizing this solution mixture by means of air (atomizing air) or an inert gas, and mixing it with a fuel gas and air (primary air) and burning the mixture in a flame into a reaction chamber. The hot gases and the solid product are cooled and the solid product is subsequently separated off from the gases. The content of the zirconium dioxide precursor, calculated as ZrO₂, in the solution here is at least 15 wt. % and not more than 35 wt. %. In addition, air (secondary air) or an inert gas, in each case in an amount which corresponds to 50% to 150% of the amount of primary air, is introduced into the reaction chamber, the ratio, defined as lambda, of oxygen present from the air employed/oxygen necessary for combustion of the fuel gas being 2 to 4.5, the dwell time of the precursors in the flame being 5 to 30 milliseconds and the content of precursor solution in the amount of gas which results after combustion of the fuel gas by air being 0.003 to 0.006 vol. %. Suitable organic zirconium dioxide precursors are zirconium(IV) ethylate, zirconium(IV) n-propylate, zirconium(IV) n-propylate, zirconium(IV) iso-propylate, zirconium(IV) n-butylate, zirconium(IV) tert-butylate and/or zirconium(IV) 2-ethyl-hexanoate. Suitable inorganic yttrium oxide precursors are yttrium nitrate, yttrium carbonate and/or yttrium sulfate.

The zirconium mixed oxide powder and the process for its preparation are described in the German patent application with the application number DE 102004039139.4 and the application date of 12 Aug. 2004. Reference is made to this application in its full scope.

A zirconium dioxide powder which has a content of zirconium dioxide of at least 92 wt. %, of yttrium oxide of from 4.5 to 5.5 wt. % and of chloride of not more than 0.05 wt. % may be particularly preferred.

The powder present in the dispersion according to the invention has no internal surface. Photographs of the powder by means of a high-resolution TEM are a suitable analysis for this purpose.

The BET surface area of the powder present in the dispersion according to the invention is 60±15 m²/g, a value of between 60±5 m²/g being preferred.

A content of zirconium dioxide powder or zirconium mixed oxide powder in the dispersion according to the invention of 50±5 wt. %, based on the total amount of the dispersion, is furthermore preferred.

The dispersion according to the invention has an excellent stability towards sedimentation, caking and thickening. It is pourable at room temperature for at least 1 month, as a rule at least 6 months, without prior redispersing being necessary.

The dispersion according to the invention can have a viscosity of less than 1,000 mPas, and particularly preferably one of less than 100 mPas, in a shear gradient range of from 1 to 1,000 s⁻¹ at a temperature of 23° C.

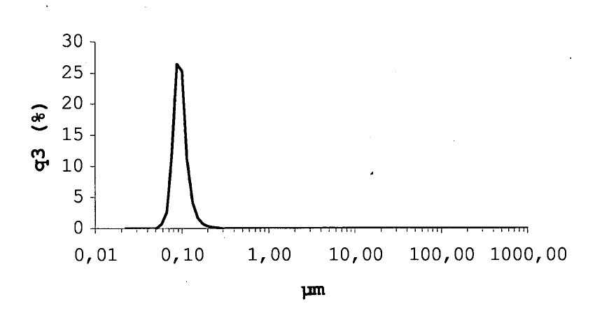

The dispersion according to the invention can preferably be in monomodal form, which means that the distribution function of the aggregate diameters shows only one signal. FIG. 1 shows a dispersion according to the invention (Example D-2).

The present invention also provides a process for the preparation of the dispersion according to the invention, by
first introducing a zirconium dioxide powder and/or a zirconium mixed oxide powder having a ZrO₂ content of at least 70 wt. %, the powder being in the form of aggregated primary particles having a BET surface area of 60±15 m²/g, all at once or in portions under dispersing conditions with an energy input of less than 200 kJ/m³, into the dispersing agent, preferably water, which contains at least one surface-modifying agent which is soluble in the dispersing agent and optionally additives for regulation of the pH
the amount of powder being chosen such that the content of powder is 30 to 75 wt. %, and the amount of surface-modifying agent being chosen such that the content of surface-modifying agent is 0.1 to 5 wt. %, in each case based on the total amount of the predispersion,
dividing the predispersion into at least two part streams, placing these part streams under a pressure of at least 500 bar, preferably 500 to 1,500 bar, particularly preferably 2,000 to 3,000 bar in a high-energy mill, letting them down via a nozzle and allowing them to collide in a gas- or liquid-filled reaction chamber and thereby grinding them, and optionally subsequently adjusting the dispersion to the desired content with further dispersing agent.

The process according to the invention can be carried out such that the dispersion which has already been ground once is circulated and is ground by means of the high-energy mill a further 2 to 6 times. It is thus possible to obtain a dispersion having a lower particle size and/or a different distribution, for example monomodal or bimodal.

The process according to the invention can furthermore preferably be carried out such that the pressure in the high-energy mill is 2,000 to 3,000 bar. With this measure it is also possible to obtain a dispersion having a lower particle size and/or a different distribution, for example monomodal or bimodal.

It is furthermore advantageous to carry out the process according to the invention such that the maximum temperature during the preparation of the (pre-)dispersion does not exceed 40° C.

The dispersion according to the invention can be used for the production of ceramic layers, ceramic membranes and shaped articles. Suitable processes for this purpose are known to the person skilled in the art, and examples which may be mentioned are gel casting, freeze casting, slip casting, vacuum hot casting, uniaxial dry pressing and cold isostatic repressing. The dispersion according to the invention can furthermore be used for polishing glass surfaces and metal surfaces.

### EXAMPLES

### Analysis

The median value is determined by means of dynamic light scattering. Apparatus employed: Horiba LB-500

The viscosity of the dispersion is determined by means of a Brookfield rotary viscometer at 23° C. as a function of the shear gradient.

The BET surface area is determined in accordance with DIN 66131.

### Powders:

Powder P1: Solution 1 and solution 2 are mixed in a ratio of 90:10 at a temperature of 50° C. 1,500 g/h of the resulting homogeneous solution are atomized with 5 Nm³/h of air by means of a nozzle having a diameter of 0.8 mm.

TABLE 1
Solutions employed for the preparation of
the zirconium/hafnium mixed oxide powder

| Solution | 1 | 2 | 3 |
|---|---|---|---|
| Zirconium octoate (as ZrO₂) | 24.40 | — | — |
| Hafnium octoate (as HfO₂) | 0.30 | — | — |
| Zirconium n-propanolate (as ZrO₂) | — | 27.80 | — |
| Hafnium n-propanolate (as HfO₂) | — | 0.50 | — |
| Yttrium nitrate Y(NO₃)₃*4H₂O | — | — | 30.7 |
| Octanoic acid | 39.60 | — | — |
| n-Propanol | — | 30.50 | — |
| Tetra-n-propanolate | — | 41.20 | — |
| 2-(2-Butoxyethoxy)ethanol | 3.50 | — | — |
| White spirit | 32.20 | — | — |
| Acetone | — | — | 69.3 |

TABLE 2
Physico-chemical properties of P1

| | | |
|---|---|---|
| Content of ZrO₂ | wt. % | 98.72 |
| Content of HfO₂ | wt. % | 1.28 |
| Content of chloride | ppm | 330 |
| BET surface area | m²/g | 63 |
| Average Ø of primary particles | nm | 13 |
| Aggregate parameters | | |
| Average circumference | nm | 494 |
| Average area | nm² | 5228 |
| Average ECD | nm | 66 |
| Average maximum diameter | nm | 112 |
| Average minimum diameter | nm | 69 |
| ZrO₂ monoclinic/tetragonal(XRD) | | 64/36 |
| Tamped density | g/l | 95 |
| Loss on drying | wt. % | 1.03 |
| Loss on ignition | wt. % | 2.08 |
| PH | | 5.32 |

The aerosol formed is transferred into a flame formed from hydrogen (5.0 Nm³/h) and primary air (10 Nm³/h) and burned into a reaction chamber.

20 Nm³/h of (secondary) air are moreover introduced into the reaction chamber. The hot gases and the solid product are then cooled in a cooling zone. The zirconium/hafnium mixed oxide powder obtained is deposited in filters.

### Powder P2:

Precursor solutions employed: Solution 1 in an amount of 312 g/h (based on zirconium dioxide) and solution 3 in an amount of 7.0 g/h (based on yttrium oxide) are mixed. The mixture remains stable, no precipitates form.

The mixture, total amount including the solvents 1,300 g/h, is then atomized with air (3.5 Nm³/h). The droplets obtained have a drop size spectrum d₅₀ of from 5 to 15 μm. The droplets are burned in a flame, formed from hydrogen (1.5 Nm³/h) and primary air (12.0 Nm³/h), into a reaction chamber. 15.0 Nm³/h of (secondary) air are moreover introduced into the reaction chamber. The hot gases and the solid products are then cooled in a cooling zone. The yttrium-stabilized zirconium dioxide obtained is deposited in filters.

TABLE 3
Physico-chemical properties of P2

| | | |
|---|---|---|
| BET surface area | m²/g | 47 |
| Ø of primary particles | nm | 13.7 |
| Av. aggregate diameter | nm | 111 |
| Content of ZrO₂ in the powder | wt. % | 94.6 |
| Content of Y₂O₃ in the powder | wt. % | 5.4 |
| Content of Y₂O₃ in the primary | wt. % | 5.2 ± 0.4 |
| particles (TEM/XRD) | | |
| ZrO₂ monoclinic/tetragonal (XRD) | % | 7/93 |
| Content of chloride | wt. % | <0.05 |
| Content of carbon | ppm | 0.12 |

### Dispersions

### Example D1

### Predispersion, Comparison Example

42.14 kg of completely demineralized water and 1.75 kg Dolapix CE64 (Zschimmer und Schwarz) are initially introduced into a preparation tank, and 43.9 kg of powder P1 are then added under shear conditions with the aid of the suction pipe of the Ystral Conti-TDS 3 (stator slit: 4 mm ring and 1 mm ring, rotor/stator distance approx. 1 mm). When the sucking in has ended, the suction connection is closed and the dispersion is subjected to further after-shear forces at 3,000 rpm for 10 min. The (pre-)dispersion obtained in this way has a content of zirconium mixed oxide powder of 50 wt. % and a median value of 614 nm. It sediments within one month.

### Example D2

### According to the Invention

This predispersion is fed in five passes through a Sugino Ultimaizer HJP-25050 high-energy mill under a pressure of 2,500 bar with diamond nozzles of 0.3 mm diameter. The dispersion obtained in this way has a median value of 112 nm and a viscosity at 100 s⁻¹ of 27 mPas. It is stable to sedimentation, caking and thickening for at least 6 months.

Sintering of uniaxially produced compacts (200 and 300 MPa) of D2 already starts at temperatures of about 1,000° C. and reaches 97% of the theoretical density at 1,300° C.

### Example D3

### According to the Invention

analogously to Example D1, a predispersion is first prepared, but using 0.88 kg of tetramethylammonium hydroxide solution (25 wt. % in water) instead of Dolapix CE64. The dispersion according to the invention is then prepared analogously to Example D2. It has a content of zirconium mixed oxide powder of 50.5 wt. %, a median value of 117 nm and a viscosity at 1,000 s⁻¹ of 32 mPas. It is stable to sedimentation, caking and thickening for at least 6 months.

### Example D4

### According to the Invention

analogously to Example D1, a predispersion is first prepared, but using powder P2. The dispersion according to the invention is then prepared analogously to Example D2. It has a content of zirconium mixed oxide powder of 50 wt. %, a median value of 99 nm and a viscosity at 1,000 s⁻¹ of 27 mPas. It is stable to sedimentation, caking and thickening for at least 6 months.

### Example D5

### Comparison Example

analogously to Example 1, an attempt is made to prepare a predispersion without using a surface-modifying agent. However, only a maximum degree of filling of 15 wt. % can be achieved.

1. A dispersion of zirconium dioxide having a solids content of from 30 to 75 wt %, based on the total amount of the dispersion, and a median value of the particles in the dispersion of less than 200 nm, obtainable by predispersing a zirconium dioxide powder and/or a zirconium mixed oxide powder having a ZrO₂ content of at least 70 wt. %, the powders being in the form of aggregated primary particles and having no internal surface and a BET surface area of the powder of 60±15 m²/g, in a dispersing agent in the presence of from 0.1 to 5 wt. %, based on the total amount of the dispersion, of a surface-modifying agent with an energy input of less than 200 KJ/m³, dividing the predispersion obtained into at least two part streams, placing these part streams under a pressure of at least 500 bar in a high-energy mill and decompress them via a nozzle, these part streams colliding with one another in a gas- or liquid-filled reaction chamber and thereby being ground, and optionally subsequently adjusting the dispersion to the desired content with further dispersing agent.

2. The dispersion of zirconium dioxide according to claim 1, wherein the surface-modifying agent is 3-aminopropyltriethoxysilane, an ammonium salt of a polycarboxylic acid and/or a tetraalkylammonium hydroxide.

3. The dispersion of zirconium dioxide according to claim 1, wherein the dispersing agent is water.

4. The dispersion of zirconium dioxide according to claim 1, wherein the predispersed powder has a content of zirconium dioxide of at least 95 wt. %, of hafnium dioxide of from 0.5 to 4 wt. % and of chloride of not more than 0.05 wt. %.

5. The dispersion of zirconium dioxide according to claim 1, wherein the predispersed powder has a content of zirconium dioxide of at east 92 wt. %, of yttrium oxide of from 4.5 to 5.5 wt. % and of chloride of not more that 0.05 wt. %.

6. The dispersion of zirconium dioxide according to claim 4, wherein the BET surface area is 60±5 m²/g.

7. The dispersion of zirconium dioxide according to claim 4, wherein the powder has a tamped density of 100±20 g/l.

8. The dispersion of zirconium dioxide according to claim 1, wherein the solids content is 50±5 wt. %.

9. The dispersion zirconium dioxide according to claim 1, wherein a viscosity is less than 1,000 mPas in the shear gradient range of from 1 to 1,000 s⁻¹ and at 23° C.

10. The dispersion of zirconium dioxide according to claim 1, wherein the dispersion is bimodal.

11. A process for the preparation of the dispersion of zirconium dioxide according to claim 1, comprising the steps:
a zirconium dioxide powder and/or a zirconium mixed oxide powder having a ZrO₂ content of at least 70 wt. %, the powder being in the form of aggregated primary particles having a BET surface area of 60±15 m²/g, is first introduced, all at once or in portions under dispersing conditions with an energy input of less than 200 kJ/m³, into the dispersing agent, preferably water, which contains at least one surface-modifying agent which is soluble in the dispersing agent and optionally additives for regulation of the pH, and a predispersion is produced in this way, the amount of powder being chosen such that the solids content is 30 to 75 wt. % and the amount of surface-modifying agent being chosen such that the content of surface modifying agent is 0.1 to 5 wt. %, in each based on the total amount of the predispersion, and
the predispersion is divided into at least two part streams, these part streams are placed under a pressure of at least 500 bar in a high-energy mill and are decompressed via a nozzle and allowed to collide in gas- or liquid-filled reaction chamber are thereby ground, and the dispersion is optionally subsequently adjusted to the desired content with further dispersing agent.

12. The process according to claim 11, wherein the dispersion which has already been ground once is circulated and is ground by means of the high-energy mill a further 2 to 6 times.

13. The process according to claim 11, wherein the pressure in the high-energy mill is 2,000 to 3,000 bar.

14. The process according to claim 11, wherein the maximum temperature during the preparation of the pre-(dispersion) is 40° C.

15. (canceled)

16. A method of producing ceramic layers, ceramic membranes, ceramic shaped articles, and polishing glass surfaces and metal surfaces, comprising casting, dry pressing, or cold isostatic pressing the dispersion onto a sample.
